(19) United States
(12) Patent Application Publication
(10) Pub. No.: US 2006/0125656 A1
(43) Pub. Date: Jun. 15, 2006

(54) Stop indicator particularly for vehicle parking

(76) Inventors: Claudio Nicolli, Molvena (Vicenza) (IT); Ruggero Meneghini, Caltrano (Vicenza) (IT)

Correspondence Address: COLEMAN SUDOL SAPONE, P.C., 714 COLORADO AVENUE, BRIDGE PORT, CT, 06605-1601, US

(21) Appl. No.: 11/280,966

(22) Filed: Nov. 16, 2005

(30) Foreign Application Priority Data
Nov. 19, 2004 (IT) VI2004A000268

(51) Int. Cl. G08G 1/14

(52) U.S. Cl. 340/932.2

(57) ABSTRACT

A stop indicator, particularly for vehicle parking, having a main body which can be applied to a support, for example a wall. The stop indicator has a push-operated activation device, which interacts with an actuator which is functionally connected to a stop indication device.

The present invention relates to a stop indicator particularly for vehicle parking.

As is known, as a consequence of the large number of circulating vehicles, ever-increasing importance is given to the possibility to reduce the space reserved for the vehicles while parked.

This need, which in any case seems to be legitimate, unfortunately affects parking maneuvers, which in some cases tend to become very difficult due to the limited space reserved to each vehicle, and can lead, if one is not careful, to accidentally colliding with the wall of the garage, causing damage to the vehicle body.

In order to solve these problems, vehicles which belong to the most luxurious categories are equipped very often with sophisticated and expensive systems for detecting the distance from an obstacle, which unfortunately, in addition to not being affordable for any user, by being based exclusively on the use of ultrasonic detectors or the like combined with the use of acoustic indicators do not provide an actual physical barrier for protecting the vehicle against accidental impact.

Other cheaper systems, based instead on photocell detectors, can also be applied in the garages, but their installation is generally reserved to specialized personnel, and even these devices do not offer a protection that allows the user of the vehicle to utilize all the space available without running the slightest risk of collisions with the wall, which are damaging and unpleasant even if they are slight.

The aim of the invention is therefore to solve the problems described above by providing a stop indicator particularly for vehicle parking which allows to minimize the space between the wall and the bumper of the vehicle, avoiding excessive forward movement and any damage to the vehicle.

Within the scope of this aim, a particular object of the invention is to provide a stop indicator which can be installed easily and is simple to use, since it can be operated by physical contact on the part of a vehicle.

Another object of the invention is to provide a stop indicator which is sturdy but can be manufactured at competitive costs.

This aim and these and other objects which will become better apparent hereinafter are achieved by a stop indicator particularly for vehicle parking, which includes a main body which can be applied to a support and is characterized in that it includes a push-operated activation means, which interacts with an actuator which is functionally connected to a stop indication means.

Further characteristics and advantages will become better apparent from the description of two preferred but not exclusive embodiments of a stop indicator according to the invention, illustrated by way of non-limiting example in the accompanying drawings, wherein:

FIG. 1 is a perspective view of a stop indicator according to the invention;

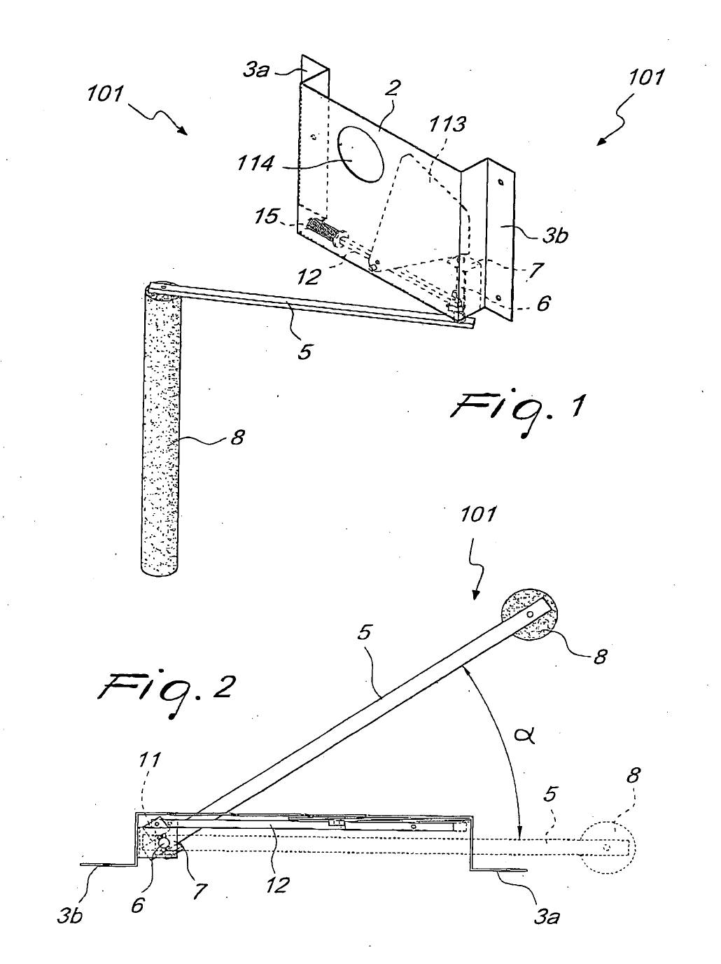

FIG. 2 is a plan view of a stop indicator according to the invention;

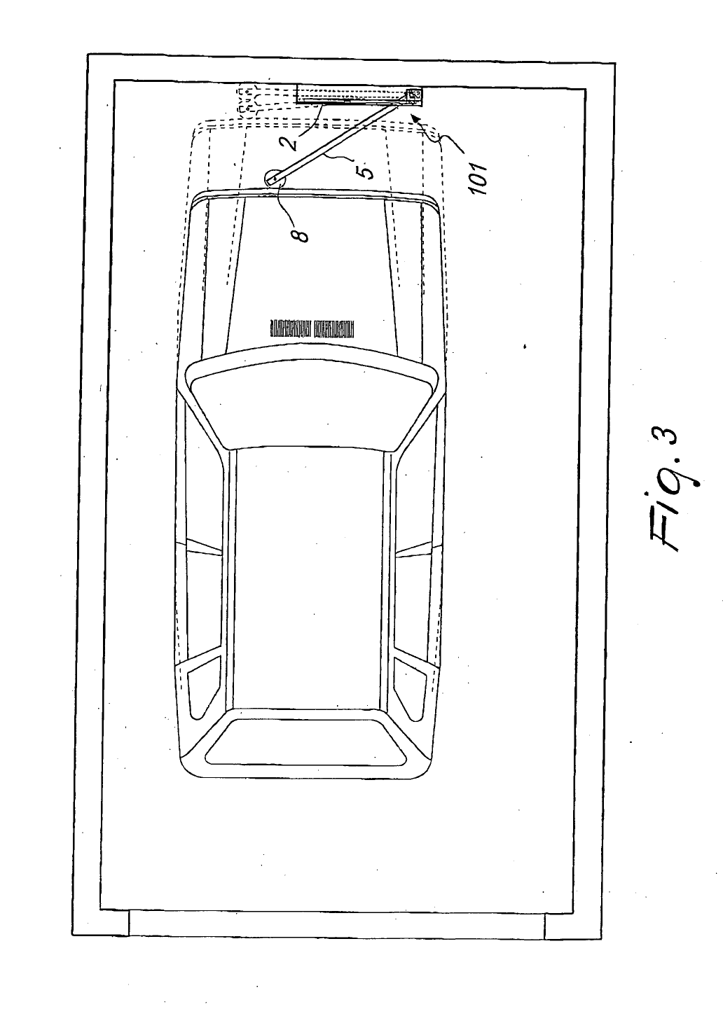

FIG. 3 is a plan view of a stop indicator according to the invention, during transition from the inactive position to the active position;

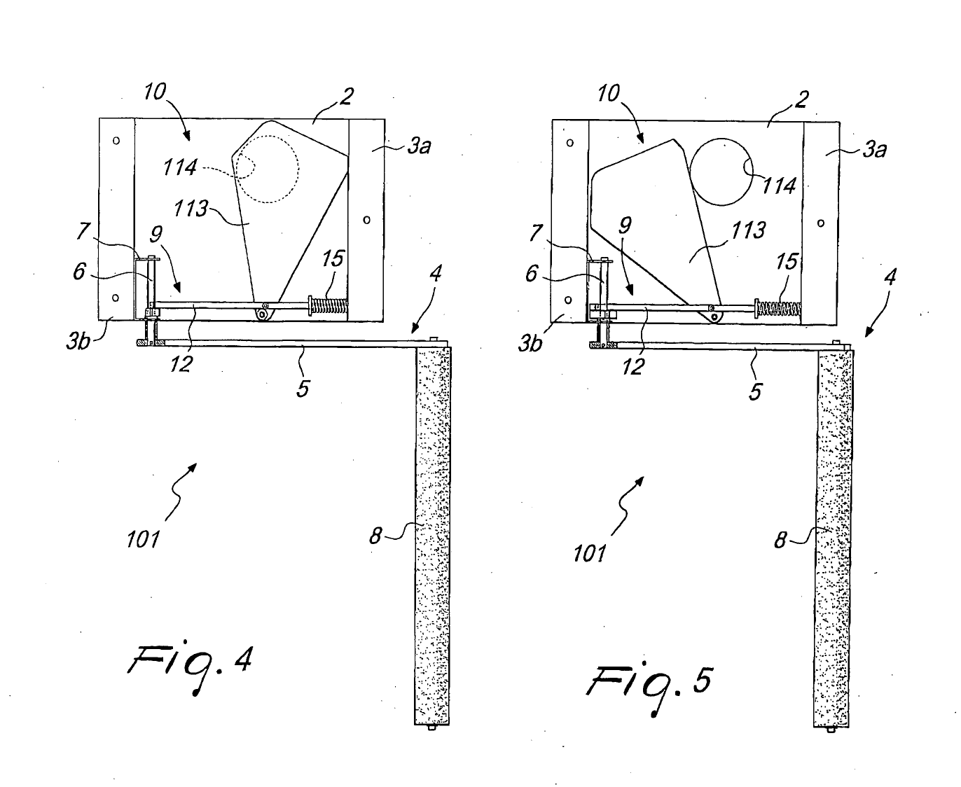

FIG. 4 is a rear view of a stop indicator according to the invention, in the active position;

FIG. 5 is a rear view of the stop indicator of FIG. 4, in the inactive position;

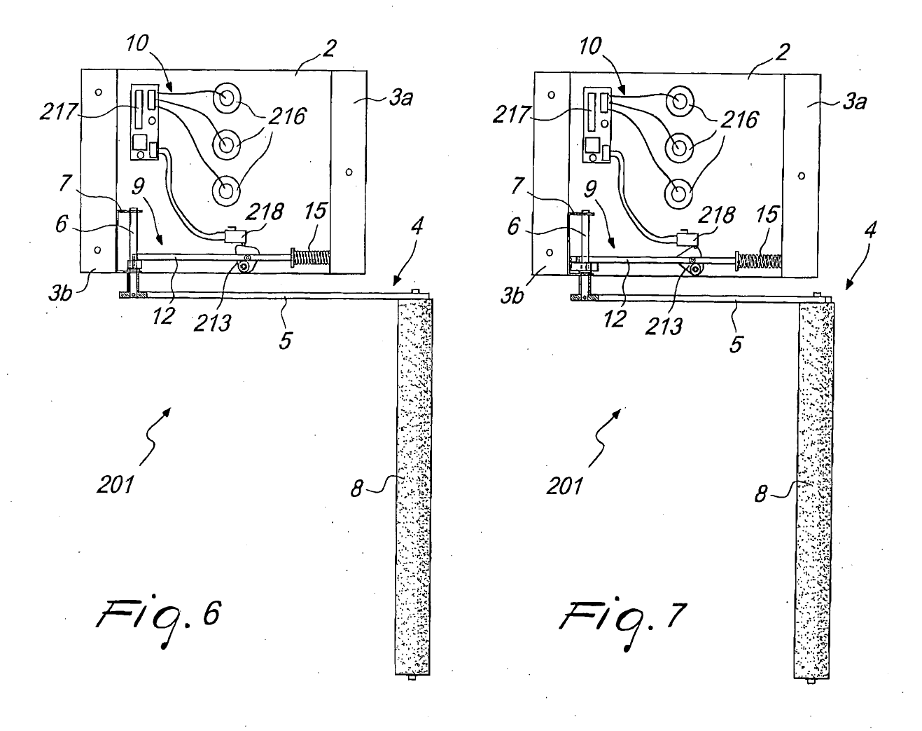

FIG. 6 is a rear view of a different embodiment of a stop indicator according to the invention, in the active position;

FIG. 7 is a rear view of the different embodiment of the stop indicator of FIG. 6, in the inactive position.

With reference to the figures cited above, a first embodiment of a stop indicator, generally designated by the reference numeral 101, includes a main box-like body 2, which is provided with perforated supports 3a and 3b for fixing the entire device to a wall, preferably by using screws and expansion plugs.

According to the invention, there is a push-operated activation means, generally designated by the reference numeral 4, which is advantageously constituted by at least one oscillating member 5, which is articulated to the main body 2 by virtue of a pivot 6, which is pivoted to an appropriately provided support 7, which is joined internally to the main body.

The oscillating member 5 is free to rotate partially on a first ideal plane, which lies transversely to the wall and forms thereon an oscillation angle which is comprised between its free end and a second ideal plane, which is substantially parallel to the wall and passes through the pivot 6.

Furthermore, the oscillating member 5 includes at least one portion which is protected by a padding 8, which transmits to the member the thrust produced by the bumper of a vehicle and allows the entire indicator to pass from an inactive position, in which the oscillation angle is an acute angle which assumes its maximum value, to an active position, in which the oscillation angle is substantial nil and the portion protected by a padding 8 is forced between the bumper and the wall to which the entire stop indicator is fixed.

The portion protected by padding 8 is furthermore meant to act as protection in order to physically separate, by means of its thickness, the wall from the bumper, preventing the bumper from being damaged due to contact with the rough and inelastic surface of the wall.

The invention furthermore provides for the presence of an actuator, generally designated by the reference numeral 9, which interacts with the push-operated activation means 4 and is functionally connected to a stop indication means, generally designated by the reference numeral 10.

The actuator 9 is conveniently constituted by a cam 113 and by a kinematic chain, which is meant to activate the stop indication means 10 during the transition of the oscillating member 5 from the inactive position to the active position defined above.

The kinematic chain is constituted essentially by a crank 11, which is rigidly coupled to the pivot 6, and by a rod-like linkage 12, which is articulated thereto.

The cam 113 is pivoted simultaneously to the main body 2, forming a first pivoting axis of the cam, and to the rod-like linkage 12, forming a second pivoting axis for the cam, which does not coincide with the preceding one, so that the movement of the oscillating member 5 produces the axial sliding of the rod-like linkage 12 and accordingly causes the partial rotation of the cam 113.

In the first embodiment of the stop indicator 101, the stop indication means 10 is constituted by the cam 113 itself and by an opening 114 which is formed on the main body 2, so as to highlight the wall during the inactive position and the surface of the cam 113 during the active position.

The portion of the cam 113 which, during transition from the inactive position to the active position, gradually becomes more visible through the opening 114 is advantageously painted red, a color which is universally associated with stop indications.

The stop indicator furthermore includes an automatic return mechanism, which is constituted advantageously by at least one helical spring 15, which is fitted partially on the rod-like linkage 12, on which it engages, so as to abut against the main body 2 so as to allow the oscillating member 5 to pass automatically from the active position to the inactive position when the pushing action of the vehicle bumper ceases.

FIGS. 6 and 7 illustrate a stop indicator according to another aspect of the invention, generally designated by the reference numeral 201, in which the stop indication means 10 is constituted by a luminous-effect device 216 and optionally by an acoustic-effect device, both of which are wired to an appropriately provided electronic circuit 217, which is controlled by microswitches 218 activated by the rotary motion of a cam 213.

Although the cam 213 is suitable in its dimensions, it is connected to the rod-like linkage 12 and to the main body 2 as already described earlier for the cam 113.

In this constructive variation, the electronic circuit 217 furthermore includes an automatic power-off device, which allows to switch off the electronic circuit when the parking maneuver has been completed.

For the different embodiment shown in FIGS. 6 and 7, the parts that corresponds to the parts that have been already described with reference to the embodiment shown in FIGS. 1 to 5 have been designated by the same reference numerals.

The operation of the stop indicator according to the invention, fixed to a wall for use, is as follows.

The approach of a vehicle to the wall reduces the distance between the wall and the bumper of the vehicle, which at a certain point makes contact with the portion protected by padding 8 of the oscillating member 5, which is initially in the inactive position, in which the oscillation angle has the highest value, as shown in FIG. 3.

The gradual push produced by the bumper simultaneously causes a rotation of the pivot 6, and of the crank 11 that is rigidly coupled thereto, which is proportional to the reduction of the oscillation angle.

This rotation is transmitted first to the rod-like linkage 12 in the form of an axial translational motion and consequently to the cam 113 or to the cam 213 as a further rotation.

In the first of these two cases, the rotation of the cam 113 makes the cam visible through the opening 114 to an extent proportional to the reduction of the space between the bumper and the wall.

In this way, when the active position in which the oscillation angle is substantial nil has been reached and the portion protected by padding is blocked between the wall and the bumper, allowing to avoid damaging the bumper, a red stop indication, optionally supported by an appropriately provided graphic component, is completely visible through the opening 114.

In the second of these two cases, the rotation of the cam 213 instead activates the microswitches 219 that control the appropriately provided electronic circuit 217, so as to switch on the lights of the luminous-effect device 216 and optionally produce variations in the intensity or frequency of the sound produced by the acoustic-effect device which are proportional to the reduction of the space between the wall and the bumper.

Furthermore, reaching the active position in which the oscillation angle is substantially nil activates, after a preset time, the automatic power-off device, which deactivates the electronic circuit until the subsequent inactive position occurs.

In both cases, when the vehicle is moved away from the wall and the pushing action on the part of the bumper ceases, the automatic return mechanism brings the entire device and particularly the oscillating member 5 to the inactive position, in which the oscillation angle reaches its maximum value.

In practice it has been found that the stop indicator particularly for vehicle parking according to the invention fully achieves the intended aim, since it ensures the possibility to minimize the space between the wall and the bumper of the vehicle, avoiding excessive forward motion and any damage to the vehicle, despite being simple to use and allowing manufacture at competitive costs.

The stop indicator thus conceived is susceptible of numerous modifications and variations, all of which are within the scope of the inventive concept; all the details may furthermore be replaced with other technically equivalent elements.

In practice, the materials used, so long as they are compatible with the specific use, as well as the contingent shapes and dimensions, may be any according to the requirements and the state of the art.

1. A stop indicator particularly for vehicle parking, comprising a main body which can be applied to a support and characterized in that it comprises a push-operated activation means, which interacts with an actuator which is functionally connected to a stop indication means.

2. The stop indicator according to claim 1, characterized in that said push-operated activation means comprise at least one oscillating member, which is articulated to said main body.

3. The stop indicator according to claims 1 and 2, characterized in that said push-operated activation means comprises at least one pivot for pivoting one end of said oscillating member to said main body.

4. The stop indicator according to claims 2 and 3, characterized in that said oscillating member rotates partially on a first ideal plane, which lies transversely with respect to said wall and on which it forms an oscillation angle which is comprised between the free end of said oscillating member and a second ideal plane, which passes through said pivot and is substantially parallel to said wall, said oscillation angle being substantially nil during an active position.

5. The stop indicator according to claims 1, 2 and 4, characterized in that said oscillating member comprises at least one portion protected by padding, which in the active position is interposed between said wall and a bumper of a vehicle.

6. The stop indicator according to claims 1, 2 and 4, characterized in that said push-operated activation means comprises at least one automatic return mechanism in order to allow said oscillating member to pass automatically from said active position to an inactive position, in which said oscillation angle assumes the maximum allowed value, when the pushing action ceases.

7. The stop indicator according to one or more of the preceding claims, characterized in that said actuator comprises a kinematic chain for activating said stop indication means during the transition of said oscillating member from said inactive position to said active position.

8. The stop indicator according to claims 3 and 7, characterized in that said kinematic chain comprises at least one crank and at least one rod-like linkage, said crank being rigidly coupled to said pivot and being articulated to said rod-like linkage.

9. The stop indicator according to claims 1 and 8, characterized in that said actuator comprises at least one cam, which is pivoted simultaneously to said main body and to said rod-like linkage, with pivoting axes which do not coincide.

10. The stop indicator according to claims 6 and 8, characterized in that said automatic return mechanism is constituted by at least one helical spring, which is fitted partially on said rod-like linkage, on which it engages, said spring abutting against said main body.

11. The stop indicator according to one or more of the preceding claims, characterized in that said stop indication means comprise said cam and at least one opening formed in said main body, said cam becoming gradually more visible through said opening during the transition of said push-operated activation means from said inactive position to said active position.

12. The stop indicator according to one or more of the preceding claims, characterized in that said stop indication means comprise at least one luminous-effect device, which is wired to an appropriately provided electronic circuit and is activated by said cam during the transition of said push-operated activation means from said inactive position to said active position.

13. The stop indicator according to one or more of the preceding claims, characterized in that said stop indication means comprise at least one acoustic-effect device, which is wired to an appropriately provided electronic circuit and is activated by said cam during the transition of said push-operated activation means from said inactive position to said active position.

14. The stop indicator according to claims 12 and 13, characterized in that said electronic circuit comprises an automatic power-off device.

15. The stop indicator according to one or more of the preceding claims, characterized in that it comprises one or more of the preceding claims.
